(19) United States
(12) Patent Application Publication
(10) Pub. No.: US 2022/0009849 A1
(43) Pub. Date: Jan. 13, 2022

(54) INSECTICIDAL EFFECT OF MICRONUTRIENT FERTILIZERS

(71) Applicant: FUTURE TENSE TECHNOLOGIES DEVELOPMENT AND ENTREPRENEURSHIP, LTD., Caesarea (IL)

(72) Inventors: Yoram Tsivion, Caesarea (IL); Alberto Alma, Ivrea (IT); Francesco Tettamanzi, Saronno (IT)

(73) Assignee: FUTURE TENSE TECHNOLOGIES DEVELOPMENT AND ENTREPRENEURSHIP, LTD., Caesarea (IL)

(21) Appl. No.: 17/297,379

(22) PCT Filed: Nov. 26, 2019
(86) PCT No.: PCT/IL2019/051289

§ 371 Date: May 26, 2021

Related U.S. Application Data
(60) Provisional application No. 62/771,612, filed on Nov. 27, 2018.

(51) Int. Cl. C05D 9/02; A01N 59/20

(52) U.S. Cl. CPC C05D 9/02; A01N 59/20

(57) ABSTRACT

A method for suppressing the population of Pentatomid insect pest. According to the method, a foliar fertilizer is prepared containing at least one type of nutritive heavy metal. The fertilizer is sprayed on egg masses deposited by Pentatomid insect species, causing a significant mortality among the neonates.

### CROSS-REFERENCE TO RELATED APPLICATIONS

The present application claims priority to International Patent Application No. PCT/IL2019/051289, filed Nov. 26, 2019, which claims the benefit of U.S. Provisional Patent Application Ser. No. 62/771,612, filed, Nov. 27, 2018, both entitled “INSECTICIDAL EFFECT OF MICRONUTRIENT FERTILIZERS.” The aforementioned applications are hereby incorporated herein by reference.

### TECHNICAL FIELD

The present invention generally relates to use of agricultural fertilizer for the control of some insects.

### BACKGROUND ART

The brown marmorated stink bug Halyomorpha halys (Stal), (hereinafter H. halys) is an invasive pentatomid species native of Asia, which has been accidentally introduced in North America in the 1990s and subsequently in Europe. More than 300 species of wild and cultivated plants can be attacked by this pest, whose feeding activity induces symptoms such as seed abortion, fruit deformation and discolorations, necrosis and other tissue alterations (Rice K B, Bergh C J, Bergmann E J, Biddinger D J, Dieckhoff C, Dively G., et al. (2014): Bio ecology, and management of brown marmorated stink bug (Hemiptera: Pentatomidae) J Integr Pest Manag 5: 1-13.). Moreover, its widely aggregative behaviour observed in overwintering adults makes this insect an important household nuisance pest as well. Even though in its native area H. halys is considered only as an occasional pest of few crops (Lee et al. 2013), its high invasive potential in areas where biodimatic condition are favourable to its development makes this stink bug a very destructive pest in countries of new introduction. In Europe, H. halys was first detected in 2004 in Switzerland, where it is rarely harmful to vegetables and crops. Afterwards it was found in many countries of central and southern Europe; particularly, most of economic losses have been recorded in Italy. Indeed, in Italy H. halys has two generations per year, high reproductive rates, and high mobility. Due to reduced effectiveness and high impact of chemical control of H. halys, alternative environmentally friendly tools are under investigation (Gariepy T D, Bruin A, Konopka J, Scott-Dupree C, Fraser H, Bon M-C, Talamas E (2018): A modified DNA barcode approach to define trophic interactions between native and exotic pentatomids and their parasitoids. Mol Ecol doi: 10.1111/mec.14868.)

A promising approach for sustainable integrated control of economically relevant stink bugs pests could be the suppression of gut primary symbioses typically occurring in these insects. Indeed, similarly to other Hemiptera, pentatomids rely on obligate bacterial symbionts complementing their nutritionally unbalanced diets (Moran N A, McCutcheon J P, Nakabachi A (2008): Genomics and evolution of heritable bacterial symbionts. Annu Rev Genet 42: 165-190.) In stink bugs, these primary symbionts are hosted in caeca in the posterior midgut region. Transmission to the progeny is achieved through a distinctive strategy, diverging from transovarial transmission commonly reported for other Hemiptera. Maternal secretions containing symbiotic bacteria are smeared on or laid close to egg masses during oviposition; nymphs immediately acquire symbionts by consuming this secretion (Prado S S, Rubinoff D, Almeida R P P (2006): Vertical transmission of a pentatomid caeca-associated symbiont. Ann Entomol Soc Am 99: 577-585.). Aposymbiotic (i.e. deprived of their primary symbionts) individuals most commonly display reduced survival or fitness (Taylor et al. 2014, The Importance of Gut Symbionts in the Development of the Brown Marmorated Stink Bug, Halyomorpha halys Stal). PLOS ONE 9: e90312). During the transmission process symbionts live outside the insect gut for several days from oviposition to neonate emergence, being protected only by secretions on the egg surface.

The gut primary symbionts of H. halys, named ‘Candidatus Pantoea carbekii’ (hereafter P. carbekii) (Bansal R, Michel A P, Sabree Z L (2014): The cryptdwelling primary bacterial symbiont of the polyphagous pentatomid pest Halyomorpha halys (Hemiptera: Pentatomidae). Environ Entomol 43: 617-625.), inhabits the posterior midgut caeca of the host and the extrachorion secretions on the egg surface, and supplies the host with nutrients limited in its diet (Kenyon U, Meulia T and Sabree Z L (2015): Habitat visualization and genomic analysis of ‘Candidatus Pantoea carbekii,’ the primary symbiont of the brown marmorated stink bug. Genome Biol Evol 7: 620-635.). Moreover, preventing vertical transmission of P. carbekii heavily affects the fitness of first generation nymphs of H. halys and their progeny (Taylor C M, Coffey P L, DeLay B D, Dively G (2014): The Importance of Gut Symbionts in the Development of the Brown Marmorated Stink Bug, Halyomorpha halys (Stal). PLOS ONE 9: e90312.) The application of substances with antimicrobial activity has been tested on H. halys egg masses, in some cases showing high mortality (Mathews C R, Barry S (2014): Compost tea reduces egg hatch and early-stage nymphal development of Halyomorpha halys (Hemiptera:Pentatomidae). Fla Entomol 97: 1726-1732.). Hence, their use was proposed for symbiont-targeted control strategies against H. halys. Even though stink bug primary symbionts are regarded as a promising target for the control of H. halys (Mathews C R, Barry S (2014), above), at present specific control methods based on this strategy are still unavailable in Europe. Hence, research on European populations is required to implement integrated crop management solutions targeting the containment of this pest. In this study, the application of active substances was assessed on H. halys egg masses in laboratory conditions and also in the field. Specifically, products were selected according to actual admission in European agriculture and well-known direct or indirect protective effects from pathogenic microorganisms. Their effect on nymphal survival on selected Italian population—as in Europe most of economic damage is produced in this Country—was tested along with the interruption of P. carbekii acquisition on this strategy are still unavailable in Europe. Hence, research on European populations is required to implement integrated crop management solutions targeting the containment of this pest. In this study, the application of active substances was assessed on H. halys egg masses in laboratory conditions. Specifically, products were selected according to actual admission in European agriculture and well-known direct or indirect protective effects from pathogenic microorganisms. Their effect on nymphal survival on selected Italian population—as in Europe most of economic damage is produced in this country—was tested along with the interruption of P. carbekii acquisition.

### SUMMARY OF THE INVENTION

There is provided in accordance with embodiments of the present invention a method for suppressing the population of various pentatomid bugs. In accordance with the present invention compositions and method for such control involves the application of some fertilizers containing chelated or non-chelated heavy metals known to be otherwise deleterious to bacteria and or fungi. The suppression is realized by inducing mortality among neonates.

### BRIEF DESCRIPTION OF THE DRAWINGS

FIG. 1. Mean mortality rates recorded for H. halys neonate nymphs after treatment with different micronutrient fertilizers.

### DISCLOSURE OF THE INVENTION

In accordance with some embodiments of the present invention, mixtures of nutritive heavy metal chelated with organic acids were tested for their effect in suppressing stink bug populations. In addition, a non-chelated copper fertilizer nutrient was tested, as will be described in more detail below.

Trials were performed in DISAFA, University of Turin, Italy.

### Trials

Insects

During spring and summer of 2018, about 1,000 brown marmorated stink bug adults were collected from different wild and cultivated host plants in the Piedmont region, Italy. Field-collected adults were reared at the DISAFA laboratories, in climatic chambers at 25±1° C., with an L:D of 16:8 photoperiod, in net cages (930×475×475 mm) containing seedlings of broad bean, apples, and shelled hazelnuts obtained from the DISAFA experimental farms and never treated with insecticides. H. halys egg masses were collected daily from the mass rearing to obtain two distinct groups, corresponding to 24-hour old and 5-day old egg masses, respectively.

Egg masses treatment using micronutrient fertilizers.

Three commercially available micronutrient EC fertilizers (i.e. admitted for the EU market), suitable for organic farming, were selected: (1) a zinc (4.0%), copper (2.0%) and citric acid biocomplex (Dentamet®, Diagro Sri, Italy); (2) a zinc (4.8%), manganese (2.7%) and citric acid biocomplex (Bio-D®, Diagro); (3) a copper hydroxide 50% wettable powder (Keos®, Green Ravenna Sri, Italy). Moreover, the experimental product Dentamet® A3 (Diagro) (hereafter A3) containing citric acid, lactic acid, malic acid, zinc (4.1%), and copper (1.9%), was tested as well (4). All products were used on 24-hour old egg masses at label recommended doses: 1% v/v (corresponding to a mean of 775 g/hl) for micronutrient and citric acid biocomplexes (Dentamet®, Bio-D®, and A3), and 0.15% (w/v) for Keos®. Additionally, 0.5% (v/v) were added of a Poly-1-p-menthene-based pesticide additive (NU-FILM-P®, CBC, Italy), to increase active ingredients penetration of maternal secretions covering P. carbekii cells (Kenyon U, Meulia T and Sabree Z L (2015): Habitat visualization and genomic analysis of ‘Candidatus Pantoea carbekii,’ the primary symbiont of the brown marmorated stink bug. Genome Biol Evol 7: 620-635.). Additive concentration was selected according to the manufacturer's indications as well. Finally, an untreated control (5) and a water+0.5% additive control (6) were included. The two products showing the higher mortality rates on 24-hour old egg masses were used to perform a second experiment on 5-day old egg masses, along with controls, with the purpose to assess whether the treatment effect was visible even after a short time of product exposure.

A total of 120 egg masses were collected and randomly allocated to treatments, once the number of eggs per mass was recorded. Exposure to the products was carried out on 24-hour old and 5-day old egg masses for each treatment and water+additive control (N=10); 20 replicates for the untreated control were collected as well. The egg masses were individually placed into Petri dishes covered with filter paper, and then treated with the active substances solutions by means of a 250 ml hand sprayer (Nalgene®, NY, USA) under a fume hood. A single spray (651±7.42 ml) was applied with the hand sprayer held approximately 20 cm away from the Petri dish with the egg mass.

Nymphal Rearing

After the treatment, egg masses were individually reared in climatic chamber (25° C., RH 70%) in clear plastic Petri dishes with a wider lid with respect to the base to provide ventilation. Nymphs were provided with an organic green bean (purchased at a local farmers' market), as a food source; hatching percentages were checked daily. Newly hatched nymphs were fed with green beans until reaching second nymph instar. Mortality rates were calculated; dead nymphs were collected each day and stored at −80° C. in RNA Later® (Sigma-Aldrich, MO, USA). As live nymphs moulted to the second instar, they were collected as well and stored as described above.

Statistical Analyses

To compare egg hatching and mortality, the percentages of dead specimens were derived with respect to the total number of emerged nymphs for each egg mass. Corrected mortality rates were calculated according to the Abbott's formula with respect to untreated control (Abbott W S (1925), A method of computing the effectiveness of an insecticide. J Econ Entomol 287 18: 265-267). Moreover, absolute mortality rates were calculated as the ratio between dead I instar nymphs and hatched eggs for each egg mass, and analysed with SPSS Statistics 25 (IBM Corp. Released 2017, Armonk, N.Y., USA), using a generalized linear model (GLM) with a binomial probability distribution and logit link function. Means were separated by a Bonferroni post hoc test (P<0.05).

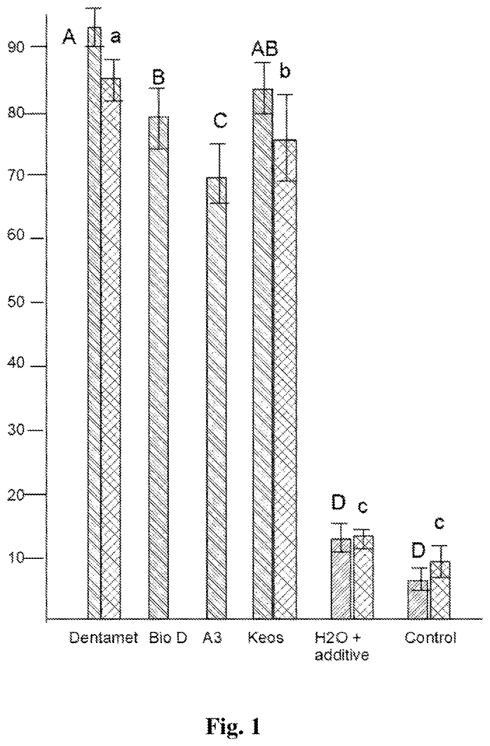

In FIG. 1, the percentage of dead nymphs before reaching II instar was calculated for 24-hour old (light hatched columns) and 5-day old (cross hatched columns) egg masses. Bars indicate standard errors. Different letters indicate significantly different values according to binomial GLM+Bonferroni's test (P<0.05); capital letters refer to experiments with 24-hour old egg masses whereas lowercase letters indicate experiments with 5-day old egg masses.

TABLE 1
Table 1. Data recorded during laboratory experimental application of micronutrient
fertilizers to 24-hour old and 5-day old H. halys egg masses. Results are expressed
as mean values ± SE. For egg hatching rates, different letters indicate significantly
different values according to binomial GLM analysis + Bonferroni's test.
Separate statistical tests were conducted for 24-hour old egg masses (df =
5; x2 = 41.376; P < 0.001) and 5-day old egg masses (df = 3; x2 = 29.332; P < 0.001).

| | | | | | Corrected |
|---|---|---|---|---|---|
| | | | | | mortality rate |
| | | | Average number | Average egg | to II nymphal |
| Egg masses age | | Treatment | of eggs per mass | hatching rate | instar (%) |
| 24 | hours | Dentamet ® | 25.8 ± 1.12 | 68.60 ± 1.78 a | 92.60 ± 0.29 |
| | | Bio-D ® | 25.6 ± 0.95 | 81.64 ± 1.24 b \hat{ } | 90.96 ± 0.86 |
| | | Keos ® | 26.0 ± 1.03 | 82.30 ± 1.22 b | 87.67 ± 1.44 |
| | | A3 | 24.2 ± 1.71 | 66.94 ± 2.20 a | 91.58 ± 0.68 |
| | | Water + additive | 19.70 ± 2.04 | 71.06 ± 1.91 ab | 64.36 ± 15.17 |
| | | Untreated control | 24.75 ± 1.46 | 82.22 ± 1.68 b | 0.00 |
| 5 | days | Dentamet ® | 26.4 ± 1.10 | 82.57 ± 2.26 c | 87.84 ± 0.76 |
| | | A3 | 21.0 ± 1.57 | 60.95 ± 1.96 a | 82.57 ± 3.38 |
| | | Water + additive | 21.1 ± 2.10 | 68.05 ± 1.77 ab | 37.25 ± 4.71 |
| | | Untreated control | 22.9 ± 1.93 | 75.10 ± 1.76 bc | 0.00 |

As can be seen from graph 1 and table 1, Dentamet® (copper and zinc combination with citric acid as a complexant) performed best in lowering the population of instar I and II nymphs, by inducing neonate mortality. As a candidate for second best, the Keos® (non chelated copper) may be found in graph 1, but if corrected to average hatching rate, Bio D° or A3, appear as better candidates.

Additional data: it was recently observed that further species of Pentatomids exhibited significant signs of vulnerability to the application of Dentamet®. Thus, application of Dentamet® on egg masses of Eurygaster maura, a parasitic Pentatomid of cereals, caused statistically significant mortality among nymphs.

1. A method for suppressing the population of Pentatomid insect, said method comprising:
a foliar fertilizer is prepared containing at least one type of nutritive heavy metal;
said fertilizer is sprayed on egg masses deposited by Pentatomid insect species.

2. A method as in claim 1 wherein said Pentatomid insect is H. halys.

3. A composition for use for the control of Pentatomid insects consisting of
at least one nutritive heavy metal otherwise used for foliar fertilizing of plants.
wherein the application of said composition to egg masses of said insect induces neonate mortality.

4. A composition as in claim 3 wherein two chelated metals are combined.

5. A composition as in claim 3 wherein none of the metals is copper.

6. A composition as in claim 3 wherein said at least one nutritive metal is chelated.
